(19) United States
(12) Patent Application Publication
(10) Pub. No.: US 2026/0188137 A1
(43) Pub. Date: Jul. 2, 2026

(54) ARTIFICIAL INTELLIGENCE (AI) EDUCATIONAL RESOURCE GENERATION SYSTEM

(71) Applicant: EDAI SYSTEMS, INC., Honolulu, HI (US)

(72) Inventor: John C. FERGUSON, Honolulu, HI (US)

(21) Appl. No.: 19/291,546

(22) Filed: Aug. 5, 2025

Related U.S. Application Data
(60) Provisional application No. 63/738,860, filed on Dec. 26, 2024.

(51) Int. Cl. G09B 7/06; G06F 16/35; G06F 40/205; G06V 30/10; G09B 7/02

(52) U.S. Cl. CPC G09B 7/06; G06F 16/35; G06F 40/205; G06V 30/10; G09B 7/02

(57) ABSTRACT

Embodiments receive a portable document format (PDF) from a user computing device; convert the PDF to a JPEG file by utilizing an artificial intelligence (AI) image segmentation model; convert the JPEG file to a text file by utilizing an AI vision workflow model; parse and classify the text file using a first large language model (LLM); determine a textual study guide using a second LLM; generate a question and answer exam based on the textual study guide using a third LLM; and generate a multiple choice question (MCQ) exam based on the question and answer exam using a plurality of LLMs.

### BACKGROUND

Aspects of the present invention relate generally to an artificial intelligence (AI) educational resource generation system and, more particularly, to systems and methods to perform artificial intelligence-driven comprehensive educational resource generation system.

A multiple choice question (MCQ) generator is a tool to automatically create multiple choice questions from various sources, such as text documents, websites, articles, etc. For example, the MCQ generator provides assessments quickly and efficiently.

### SUMMARY

In a first aspect of the invention, there is a computer-implemented method including: receiving, by a computing device, a portable document format (PDF) from a user computing device; converting, by the computing device, the PDF to a JPEG file by utilizing an artificial intelligence (AI) image segmentation model; parsing and classifying, by the computing device, the text file using a first large language model (LLM); determining, by the computing device, a textual study guide using a second LLM; generating, by the computing device, a question and answer exam based on the textual study guide using a third LLM; and generating, by the computing device, a multiple choice question (MCQ) exam based on the question and answer exam using a plurality of LLMs.

In another aspect of the invention, there is a computer program product including one or more computer readable storage media having program instructions collectively stored on the one or more computer readable storage media. The program instructions are executable to: receive a google document from a user computing device; convert the google document to a text file by using a conversion model; parse and classify the text file using a first large language model (LLM); determine a textual study guide using a second LLM; generate a question and answer exam based on the textual study guide using a third LLM; and generate a multiple choice question (MCQ) exam based on the question and answer exam using a plurality of LLMs.

In another aspect of the invention, there is a system including a processor, a computer readable memory, one or more computer readable storage media, and program instructions collectively stored on the one or more computer readable storage media. The program instructions are executable to: receive a portable document format (PDF) from a user computing device; convert the PDF to a JPEG file by utilizing an artificial intelligence (AI) image segmentation model; parse and classify the text file using a first large language model (LLM); determine a textual study guide using a second LLM; determine a semantic study guide based on the textual study guide using a vector embedding model; generate a question and answer exam based on the textual study guide using a third LLM; and generate a multiple choice question (MCQ) exam based on the question and answer exam using a plurality of LLMs.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an AI educational resource generation system in accordance with aspects of the present invention.

FIG. 5 shows an example of a flowchart of the AI educational resource generation system in accordance with aspects of the present invention.

FIG. 6 shows another example of a flowchart of the AI educational resource generation system in accordance with aspects of the present invention.

FIG. 7 shows another example of the flowchart of the AI educational resource generation system in accordance with aspects of the present invention.

FIGS. 8-24 show graphical user interface (GUI) examples of the AI educational resource generation system in accordance with aspects of the present invention.

### DETAILED DESCRIPTION

Aspects of the present invention relate generally to an artificial intelligence (AI) educational resource generation system and, more particularly, to systems and methods to perform artificial intelligence-driven comprehensive educational resource generation system. In embodiments of the present invention, the systems and methods create an educational platform which is directed to developing and managing academic content. For example, the systems and methods utilize artificial intelligence (AI) to automate the creation of sophisticated exam questions, study guides, and learning material from educational articles, research data, publications, scientific articles, etc. Accordingly, the systems and methods streamline the creation of educational content through AI-powered automation, standardization, proper citations, scalability and leveraging of diverse subjects, integration with other learning management systems (LMS), and provide accurate and reliable content. The systems and methods described herein may be implemented as a system, computer-implemented method, and/or computer program product. Although the examples of the AI educational resource generation system are directed to medical subjects, embodiments are not limited to these subjects. The AI educational resource generation system can also be applied to law, mathematics, science, technology, English, foreign languages, social studies (e.g., history, government, economics, geography, etc.), finance, business, computer science, engineering, physics, arts and humanities, natural sciences, applied sciences, etc.

More specifically, the system, computer-implemented method, or computer program product provides the AI educational resource generation system that can aid students to learn complex and diverse subjects across any educational discipline or multiple disciplines. For example, although conventional educational resource generation systems focus on basic guides, the AI educational resource generation system can generate complex study guides and learning materials which allow the students to master the material by utilizing critical analysis and problem solving.

In further embodiments, the AI educational resource generation system can aid educators and administrators in developing robust exam questions for testing. For example, although conventional educational resource generation systems focus on simple recall questions, the AI educational resource generation system can generate complex questions which require analysis, evaluation, problem solving, and application of knowledge across multiple disciplines.

Embodiments of the present invention provide a technical solution of providing an educational resource generating system based on AI. Accordingly, the technical solution addresses a technical problem of managing educational content. For example, the computer-implemented method, system, and/or computer program product creates an educational platform for developing and managing the educational content. In further embodiments, the educational platform develops and manages the educational content through AI.

In contrast, known systems involve a time-consuming process (e.g., at least 5 hours for an assessment) for managing educational content. In addition, known systems don't include standardization (e.g., inconsistent quality and format), don't include proper attribution (e.g., lack of proper citation, are not aligned with academic standards, etc.), are not able to scale (e.g., doesn't address diverse subjects), have high costs (e.g., significant financial strain on institutions and students), and are not able to leverage a team effort (e.g., responsibility for the educational content falls to one individual) For example, known systems may not provide a customized output, may not be compatible with learning management systems (LMS), may not be accurate and reliable, and may not be integrated with AI. The systems, computer-implemented method, and computer program products as described herein make improvements on the known systems by providing an automated artificial intelligence (AI) educational resource generation system which facilitates the creation of accurate, reliable, and detailed exam questions, study guides, and other learning material.

Implementations of the present invention are rooted in computer technology. For example, the present invention parses and classifies a text file using a first large language model (LLM), determines a textual study guide using a second LLM, generates a question and answer exam based on the textual study guide using a third LLM, and generates a multiple choice question (MCQ) exam based on the question and answer exam using a plurality of LLMs, which are rooted in computer technology and cannot be performed in the human mind or with pen and paper. Also, the present invention determines a textual study guide using a second LLM, generates a question and answer exam based on the textual study guide using a third LLM, and generates a multiple choice question (MCQ) exam based on the question and answer exam using a plurality of LLMs, which are clearly rooted in computer technologies and cannot be done in the human mind or by use of pen and paper. More specifically, an LLM utilizes billions of active parameters per token and billions of tokens for training data for classifying the user feedback in real time. For example, an LLM exhibits strong performance in coding, reasoning, and mathematical calculations to generate an output in real time (or near real time). In this example, the LLM exhibits strong performance in reasoning tasks such as abstract logic challenges, mathematical calculations in mathematical problem sets, and coding tasks such as code generation and debugging. Given this scale and complexity, it is simply not possible for the human mind, or for a person using pen and paper, to perform the number of calculations involved in parsing and classifying a text file, determining a textual study guide, and generating a multiple choice question (MCQ) exam. In further embodiments, the steps of training these LLM using historical textual study guides, historical semantic study guides, and historical MCQ exams are also rooted in computer technology and cannot be performed in the human mind (or with pen and paper).

It should be understood that, to the extent implementations of the invention collect, store, or employ personal information provided by, or obtained from, individuals (for example, personal identifiable information (PII), etc.), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

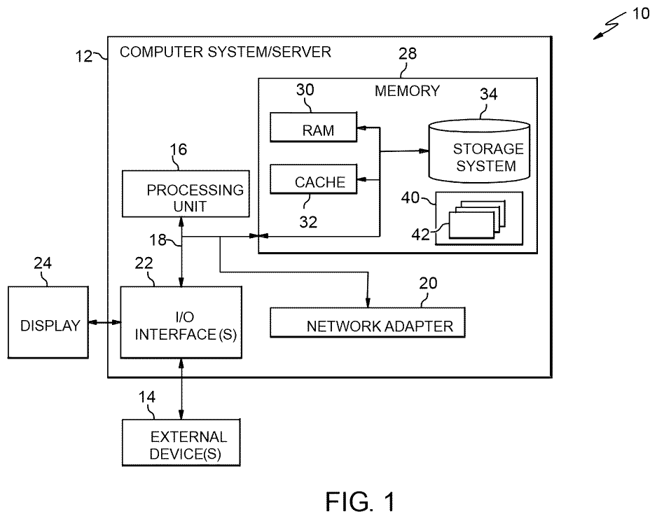

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc. ; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

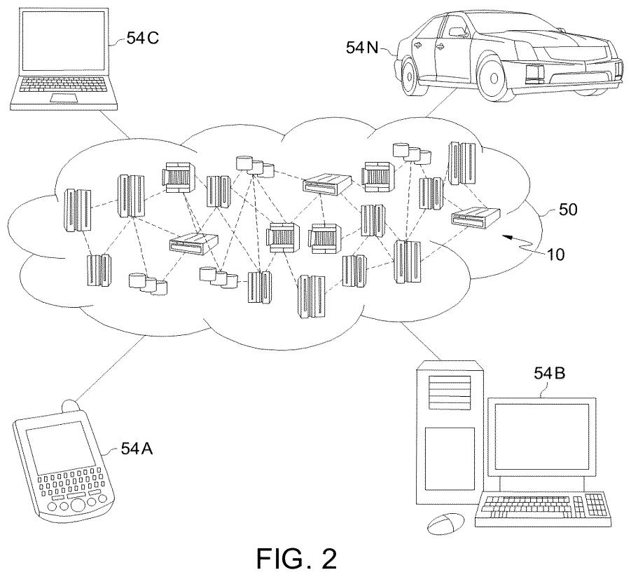

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

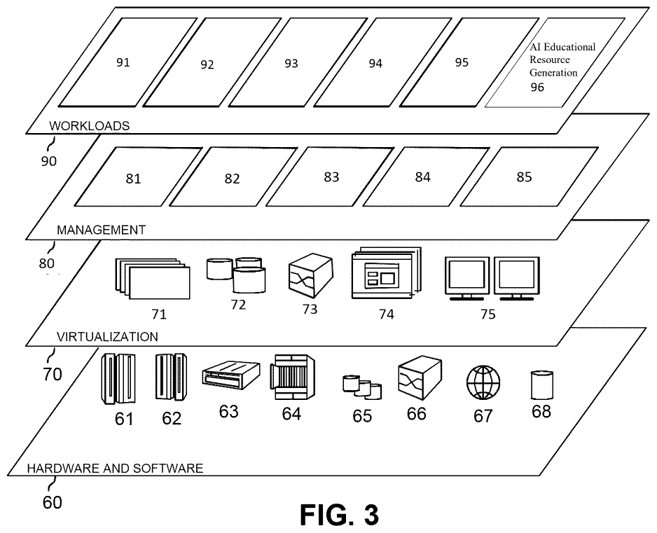

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and an AI educational resource generation 96.

Implementations of the invention may include a computer system/server 12 of FIG. 1 in which one or more of the program modules 42 are configured to perform (or cause the computer system/server 12 to perform) one of more functions of the AI educational resource generation 96 of FIG. 3. In embodiments, the AI educational resource generation 96 generates a MCQ exam based on AI. For example, the one or more of the program modules 42 of the AI educational resource generation 96 may be configured to: receive a portable document format (PDF) from a user computing device; convert the PDF to a JPEG file by utilizing an artificial intelligence (AI) image segmentation model; convert the JPEG file to a text file by utilizing an AI vision workflow model; parse and classify the text file using a first large language model (LLM); determine a textual study guide using a second LLM; generate a question and answer exam based on the textual study guide using a third LLM; and generate a multiple choice question (MCQ) exam based on the question and answer exam using a plurality of LLMs.

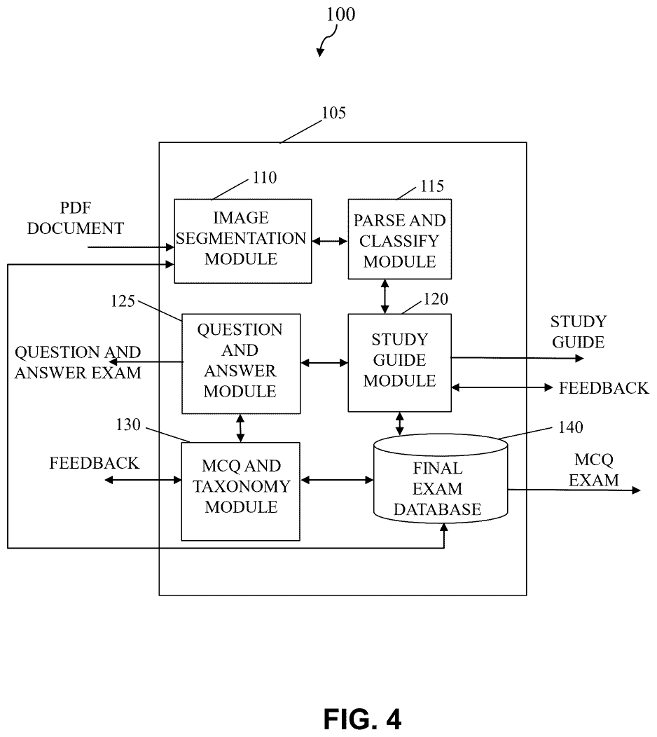

FIG. 4 shows a block diagram of an AI educational resource generation system in accordance with aspects of the invention. In embodiments, the AI educational resource generation system 100 comprises an AI educational resource generation environment 105 which includes an image segmentation module 110, a parse and classify module 115, a study guide module 120, a question and answer module 125, and a multiple choice questionnaire (MCQ) and taxonomy module 130, each of which may comprise one or more program modules such as program modules 42 described with respect to FIG. 1 and the AI educational resource generation 96 of FIG. 3.

The AI educational resource generation system 100 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4. For example, in FIG. 4, the AI educational resource generation system 100 includes a final exam database 140, which is included in the AI educational resource generation environment 105.

In embodiments of FIG. 4, the AI educational resource generation system 100 enables the system, computer-implemented method, and/or computer-program product to utilize artificial intelligence (AI) to automate the creation of sophisticated exam questions, study guides, and learning material from educational articles, research data, publications, scientific articles, etc. In particular, the AI educational resource generation system 100 utilizes artificial intelligence (AI), among other techniques, to analyze educational articles, research data, publications, scientific articles, etc., to create an education resource generation system.

In aspects of the present invention, the image segmentation module 110 receives a portable document format (PDF) document or a video from a computing device of a user. For example, the PDF document comprises at least one of an educational article, research data, a publication, a scientific article, etc. In another example, the video includes content that includes at least one of an educational article, research data, a publication, a scientific article, etc. In embodiments, the image segmentation module 110 converts the PDF document or the video to a joint photograph experts group (JPEG) file by utilizing an AI image segmentation model. In aspects of the present invention, the AI image segmentation model utilizes positional encodings, learned embeddings, and pre-trained text encoders to analyze the PDF document or the video. In further aspects, the AI image segmentation model can be trained using historical PDF documents or historical video which comprise at least one of a historical educational article, historical research data, historical publications, historical scientific articles, etc. In embodiments, the image segmentation module 110 analyzes the PDF document or the video in order to segment the PDF document or the video into objects of an image for conversion to the JPEG file.

More specifically, the image segmentation module 110 converts the JPEG file to a text file by utilizing an AI vision workflow model. In this situation, the AI vision workflow model utilizes at least one machine learning (ML) model to ingest and analyze the JPEG file for object detection and converting the detected objects into a text file. In further embodiments, the text file comprises machine readable text in a structured javascript object notation (JSON) format. Accordingly, the AI vision workflow model provides text in a structured JSON format. In aspects, the AI vision workflow model can be trained using historical JPEG files which include educational content. The image segmentation module 110 sends the text file in the structured JSON format to the parse and classify module 115.

In another embodiment, the image segmentation module 110 receives at least one of a uniform resource locator (URL), a word document, a google document, a rich text format (RTF), and a text file. In further embodiments, the image segmentation module 110 converts the at least one of the URL, the word document, the google document, the RTF, and a text document to a text file by utilizing a conversion model. In aspects, the conversion model comprises a generative transformer which is fine-tuned using reinforcement learning (RL). In an example, the RL comprises a reinforcement learning from human feedback (RLHF) algorithm. In aspects of the present invention, RLHF is a machine learning technique that utilizes human feedback to fine tune AI models (e.g., the conversion model) to better align with human preferences and values. In this scenario, the text file comprises machine readable text in a JSON format. In further embodiments, the image segmentation module 110 sends the text file in the structured JSON format to the parse and classify module 115.

In embodiments, the parse and classify module 115 parses and classifies the text file by utilizing a first large language model (LLM). In embodiments, the first LLM comprises a first generative transformer which is fine-tuned using reinforcement learning (RL). In an example, the RL comprises a reinforcement learning from human feedback (RLHF) algorithm. In aspects of the present invention, RLHF is a machine learning technique that utilizes human feedback to fine tune AI models (e.g., the first LLM) to better align with human preferences and values. In further embodiments, the parse and classify module 115 parses the text file and classifies the text file by rapid data extraction and automated labeling of the text file into a plurality of categories by utilizing the first LLM. The first LLM can be trained using historical text files which include educational content. Accordingly, the first LLM provides speed and efficiency for the parsing and classifying tasks of the text file. The parse and classify module 115 sends the classified text to the study guide module 120.

In aspects of the present invention, the study guide module 120 determines a textual study guide which includes the plurality of categories by using a second LLM. In embodiments, the second LLM comprises a second generative transformer which is fine-tuned using RL. In an example, the RL comprises a RLHF algorithm which receives feedback from the user on the determined textual study guide to improve the textual study guide and the training of the second LLM. In further embodiments, the study guide module 120 receives the classified text and generates the textual guide by utilizing the second LLM. Accordingly, the second LLM provides visual reasoning of the classified text to generate the textual study guide including the plurality of categories. In further embodiments, the second LLM can be trained using historical textual study guides. The textual study guide may also provide a summary of the classified text, citations, and further details of the classified text in a visual format which makes it easier for the reader to scan and digest a complex topic. The study guide module 120 sends the textual study guide which includes the plurality of categories to the question and answer module 125. In further embodiments, the study guide module 120 may also output the textual study guide to the computing device of the user for displaying through a first graphical user interface (GUI).

In further aspects of the present invention, the study guide module 120 also utilizes a vector embedding model to convert the determined textual study guide to a semantic study guide which includes a vector representation of the determined textual study guide and which captures the semantic meaning of the determined textual study guide. The vector embedding model can be trained using historical semantic study guides. Accordingly, the semantic study guide represents a relationship between words and concepts of the determined textual study guide and considers how the content of the determined textual study guide connects to broader themes or ideas of the content. In further embodiments, the semantic study guide helps users to build vocabulary, background knowledge, differential between related concepts, and develop a comprehensive understanding of the subject matter of the determined textual study guide. In this scenario, the study guide module 120 also receives feedback from the user on the semantic study guide to improve the semantic study guide and the training of the vector embedding model. The study guide module 120 sends the semantic study guide to the final exam database 140. The final exam database 140 includes the current semantic study guide as well as historical semantic study guides. In further embodiments, the current semantic study guide and the historical semantic study guides can also be used to train the vector embedding module. In further embodiments, the study guide module 120 may also output the semantic study guide to the computing device of the user for displaying through the first GUI.

In embodiments, the question and answer module 125 generates a question and answer exam based on the textual study guide by utilizing a third LLM which utilizes a neural network architecture. In embodiments, the third LLM comprises at least one generative transformer in the neural network architecture which is fine-tuned using RL. In an example, the RL comprises a RLHF algorithm. In further embodiments, the question and answer module 125 receives the textual study guide and generates the question and answer exam by utilizing the third LLM. Accordingly, the third LLM provides advanced reasoning, analysis, and generation of the question and answer exam by performing complex task analysis of the textual study guide. The third LLM can be trained using historical question and answer exams. The question and answer exam may include at least 125 questions and answers. In further aspects, the question and answer exam may also include a case study progression. The question and answer module 125 sends the question and answer exam to the MCQ and taxonomy module 130. In further embodiments, the question and answer module 125 may also output the question and answer exam to the computing device of the user for displaying through a second graphical user interface (GUI).

In embodiments, the MCQ and taxonomy module 130 generates multiple choice questions (MCQ) exam based on the question and answer exam by utilizing a plurality of LLMs. In embodiments, the plurality of LLMs may include a psychometric LLM and a taxonomy analyzer LLM. The psychometric LLM may utilize a third generative transformer which is fine-tuned using RL. In an example, the RL comprises a RLHF algorithm which receives feedback from the user on the generated MCQ exam to improve the generated MCQ exam and the training of the psychometric LLM. In aspects, the MCQ and taxonomy module 130 implements real-time changes based on the feedback to improve the generated MCQ. In further embodiments, the psychometric LLM utilizes a psychometric model which is trained to evaluate and provide an assessment of the question and answer exam for generating the MCQ exam. In aspects, the psychometric model is trained using historical MCQ exams. For example, the psychometric model is trained to evaluate and provide an assessment of reliability, validity, and a measure of intended psychological constructs of the question and answer exam to improve the generation of the MCQ exam. In aspects, the taxonomy analyzer LLM utilizes a classifier model (e.g., support vector machine, random forest algorithm, etc.) to classify the question and answer exam into taxonomy categories for the generated MCQ exam. The taxonomy analyzer LLM is trained using historical MCQ exams. The MCQ and taxonomy module 130 sends the generated MCQ exam with the taxonomy categories to the final exam database 140.

As shown in FIG. 4, the final exam database 140 stores the generated MCQ exam and historical MCQ exams. Accordingly, the final exam database 140 can utilize current and historical MCQ exams to train each of the models (i.e., the AI image segmentation model, the AI vision workflow model, the conversion model, the first LLM, the vector embedding model, the second LLM, the third LLM, the psychometric LLM, and the taxonomy analyzer LLM) for generating future MCQ exams. The final exam database 140 can output the generated MCQ exam and historical MCQ exams to the image segmentation module 110 to create a feedback loop for improving the AI educational resource generation system 100. The final exam database 140 can also output the generated MCQ exam to the computing device of the user for displaying through a third graphical user interface (GUI).

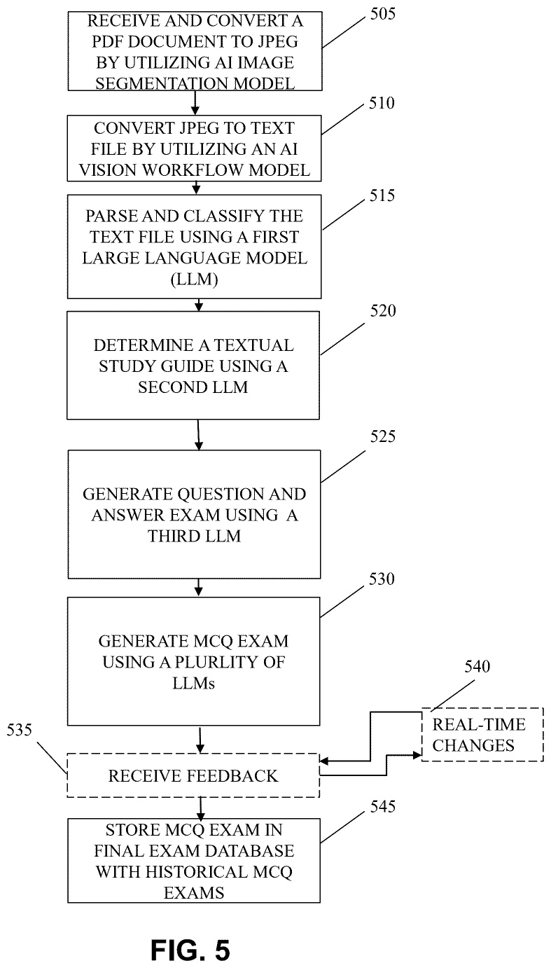

FIG. 5 shows an example of a flowchart of the AI educational resource generation system in accordance with aspects of the present invention. Steps of the method may be carried out in the AI educational resource generation environment 105 of FIG. 4.

At step 505, the system receives and converts, at the image segmentation module 110, a PDF document. In embodiments and as described with respect to FIG. 4, the image segmentation module 110 receives the pdf document from a computing device of a user and converts the PDF document to a JPEG file by utilizing an AI image segmentation module. At step 510, the system converts, at the image segmentation module 110, the JPEG file to a text file by utilizing an AI vision workflow model. At step 515, the system parses and classifies, at the parse and classify module 115, the text file using a first LLM. At step 520, the system determines, at the study guide module 120, a textual study guide using a second LLM. At step 525, the system generates, at the question and answer module 125, a question and answer exam based on the textual study guide using a third LLM. At step 530, the system generates, at the MCQ and taxonomy module 130, an MCQ exam based on the question and answer exam by using a plurality of LLMs.

At step 535, the system receives, at the MCQ and taxonomy module 130, feedback from the computing device of the user. At step 540, the system implements, at the MCQ and taxonomy module 130, real-time changes based on the feedback to improve the generated MCQ exam. In embodiments and as described with respect to FIG. 4, steps 535 and 540 are optional steps.

In an embodiment, the flowchart may go directly to step 545 from step 530. In this scenario, there is no feedback received. At step 545, the system stores, at the final exam database 140, the generated MCQ exam. In embodiments and as described with respect to FIG. 4, the final exam database 140 includes the generated MCQ exam and historical MCQ exams.

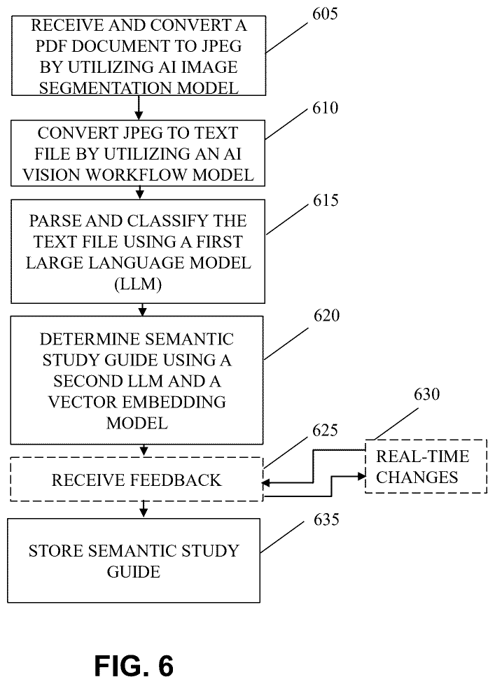

FIG. 6 shows another example of a flowchart of the AI educational resource generation system in accordance with aspects of the present invention. Steps of the method may be carried out in the AI educational resource generation environment 105 of FIG. 4.

At step 605, the system receives and converts, at the image segmentation module 110, a PDF document. In embodiments and as described with respect to FIG. 4, the image segmentation module 110 receives the pdf document from a computing device of a user and converts the PDF document to a JPEG file by utilizing an AI image segmentation module. At step 610, the system converts, at the image segmentation module 110, the JPEG file to a text file by utilizing an AI vision workflow model. At step 615, the system parses and classifies, at the parse and classify module 115, the text file using a first LLM. At step 620, the system determines, at the study guide module 120, a semantic study guide using a second LLM and a vector embedding model.

At step 625, the system receives, at the study guide module 120, feedback from the computing device of the user. At step 630, the system implements, at the study guide module 120, real-time changes based on the feedback to improve the semantic study guide. In embodiments and as described with respect to FIG. 4, steps 625 and 630 are optional steps.

In an embodiment, the flowchart may go directly to step 635 from step 620. In this scenario, there is no feedback received. At step 635, the system stores, at the final exam database 140, the semantic study guide. In embodiments and as described with respect to FIG. 4, the final exam database 140 includes the semantic study guide and historical semantic study guides.

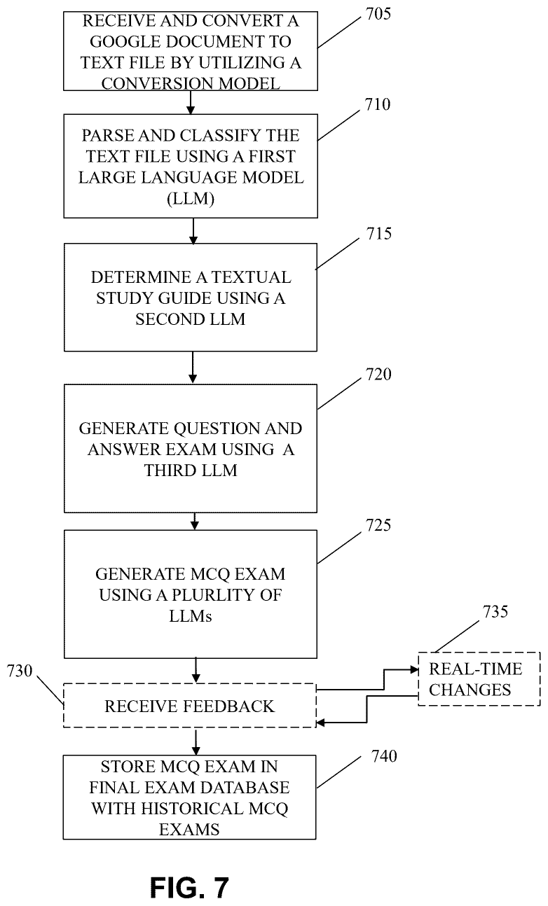

FIG. 7 shows an example of a flowchart of the AI educational resource generation system in accordance with aspects of the present invention. Steps of the method may be carried out in the AI educational resource generation environment 105 of FIG. 4.

At step 705, the system receives and converts, at the image segmentation module 110, a google document. In embodiments and as described with respect to FIG. 4, the image segmentation module 110 receives the google document from a computing device of a user and converts the google document to a text file by utilizing a conversion model. At step 710, the system parses and classifies, at the parse and classify module 115, the text file using a first LLM. At step 715, the system determines, at the study guide module 120, a textual study guide using a second LLM. At step 720, the system generates, at the question and answer module 125, a question and answer exam based on the textual study guide using a third LLM. At step 725, the system generates, at the MCQ and taxonomy module 130, an MCQ exam based on the question and answer exam by using a plurality of LLMs.

At step 730, the system receives, at the MCQ and taxonomy module 130, feedback from the computing device of the user. At step 735, the system implements, at the MCQ and taxonomy module 130, real-time changes based on the feedback to improve the generated MCQ exam. In embodiments and as described with respect to FIG. 4, steps 730 and 735 are optional steps.

In an embodiment, the flowchart may go directly to step 740 from step 725. In this scenario, there is no feedback received. At step 740, the system stores, at the final exam database 140, the generated MCQ exam. In embodiments and as described with respect to FIG. 4, the final exam database 140 includes the generated MCQ exam and historical MCQ exams.

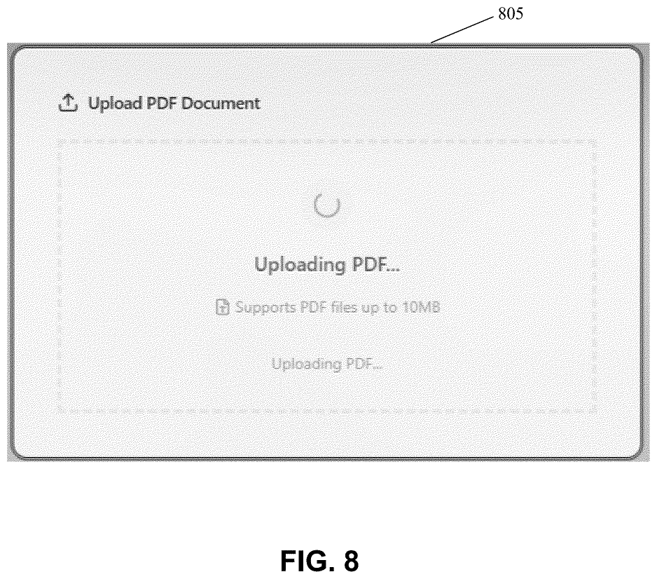

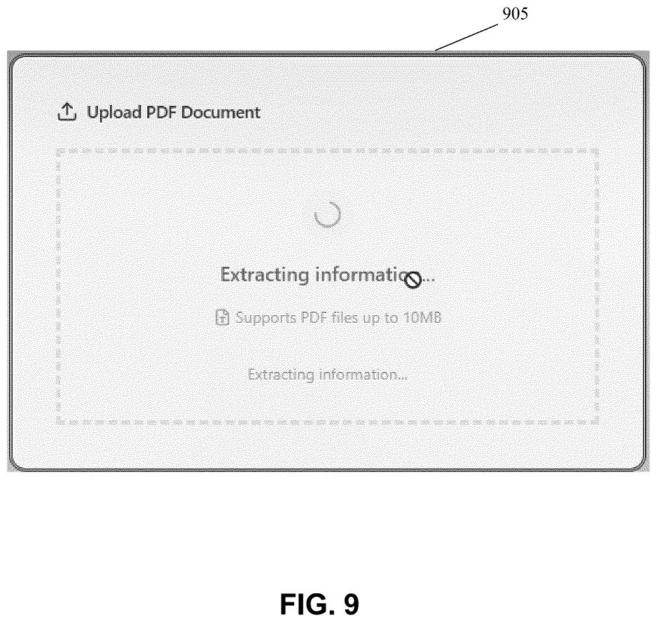

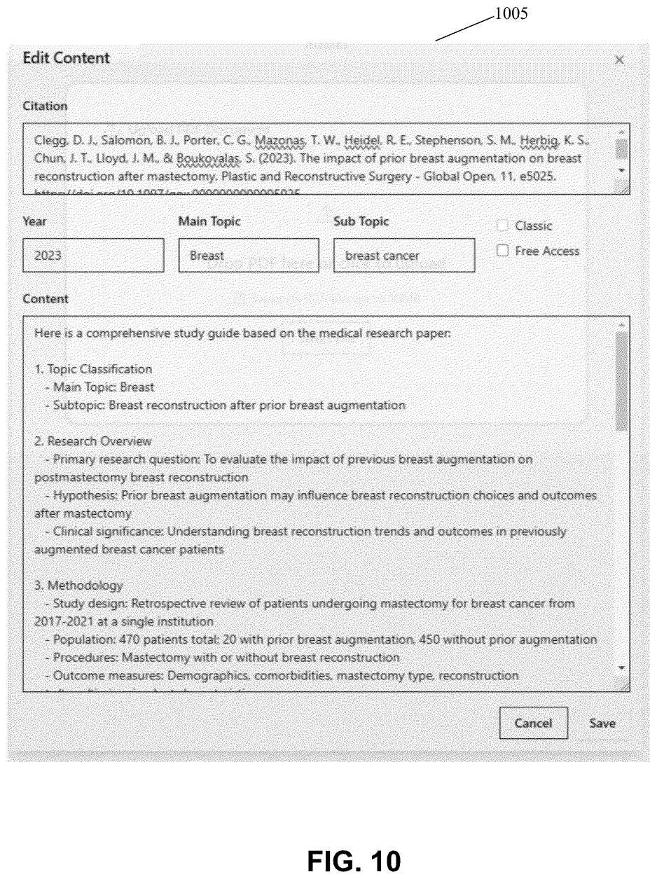

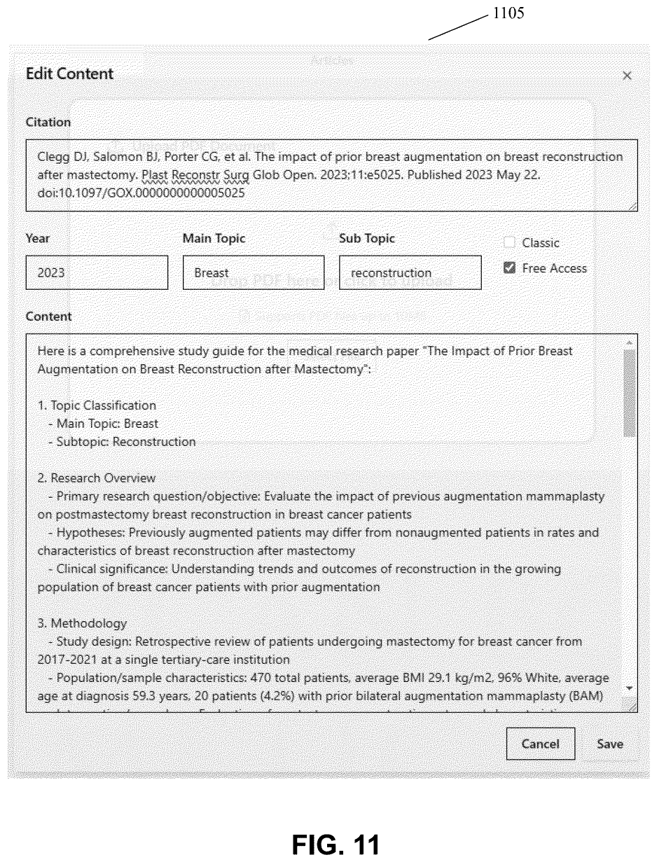

FIGS. 8-24 show graphical user interface (GUI) examples of the AI educational resource generation system in accordance with aspects of the present invention. In FIG. 8, the image segmentation module 110 receives the PDF document and converts the PDF document to a JPEG file in a first GUI example 805. In FIG. 9, the image segmentation module 110 converts the JPEG file to a text file by utilizing an AI vision workflow model in a second GUI example 905. In FIG. 10, the parse and classify module 115 parses and classifies the text file using a first LLM in a third GUI example 1005. In FIG. 11, the study guide module 120 determines a textual study guide using a second LLM in a fourth GUI example 1105.

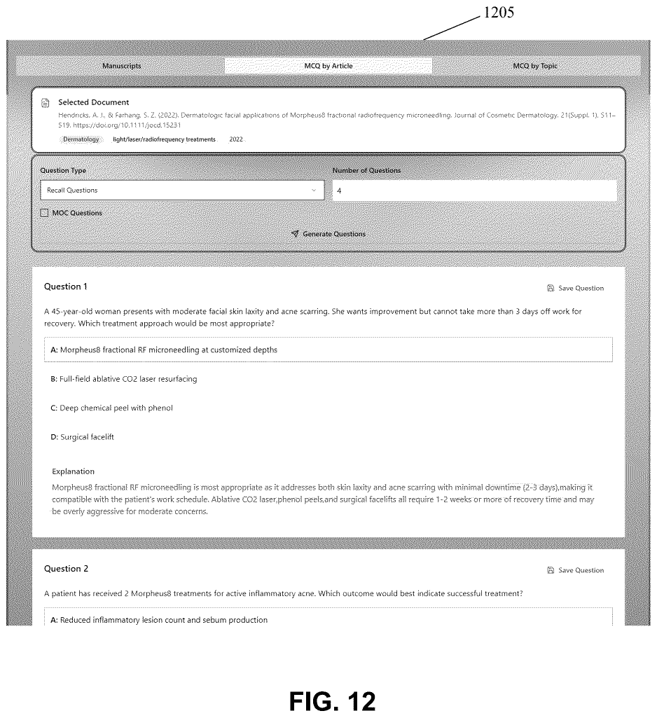

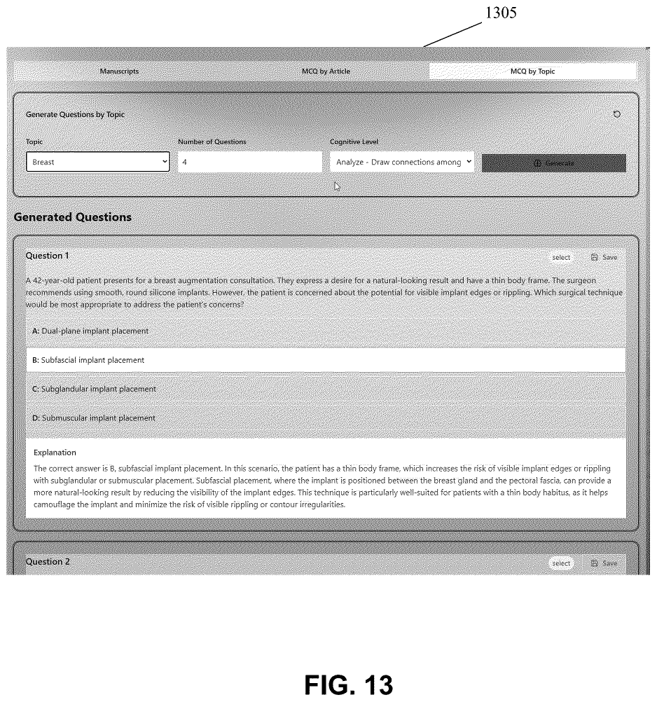

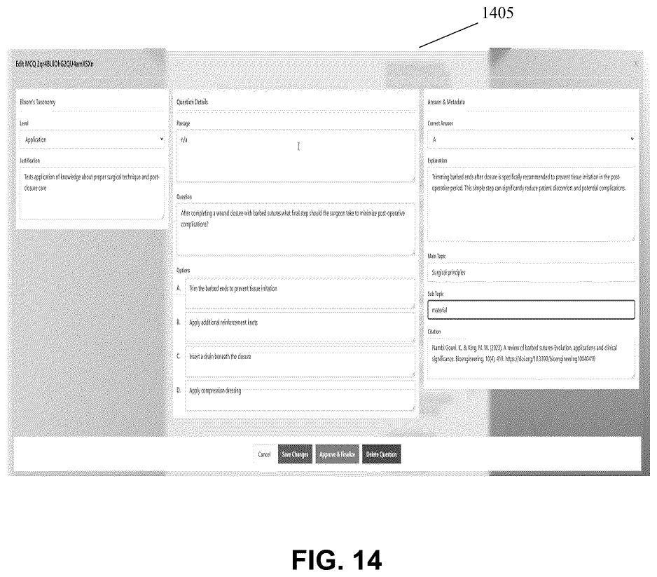

In FIG. 12, the question and answer module 125 generates a question and answer exam based on the textual study guide using a third LLM in a fifth GUI example 1205. In FIG. 13, the MCQ and taxonomy module 130 generates an MCQ exam based on the question and answer exam using a plurality of LLMs in a sixth GUI example 1305. In FIG. 14, the MCQ and taxonomy module 130 receives feedback on the MCQ exam in a seventh GUI example 1405. For example, the feedback from the computing device of the user can include “approve and finalize”, “save changes”, “cancel”, and “delete question” in the seventh GUI example 1405.

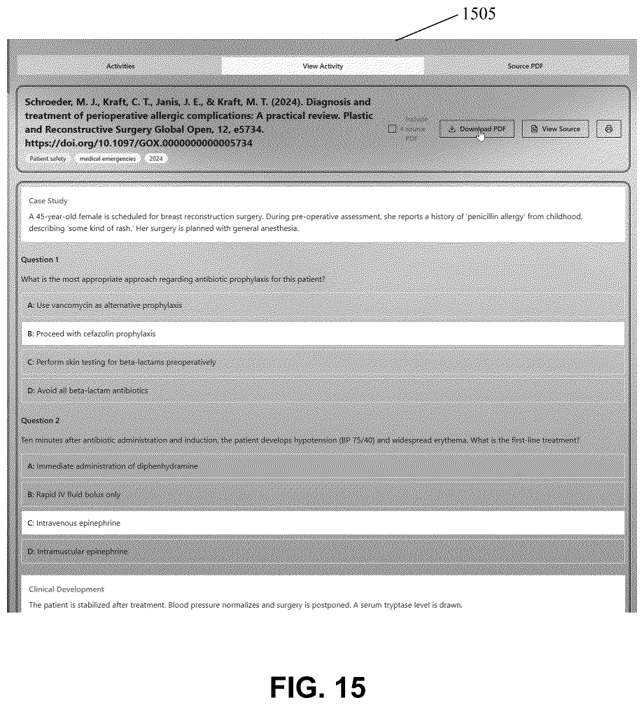

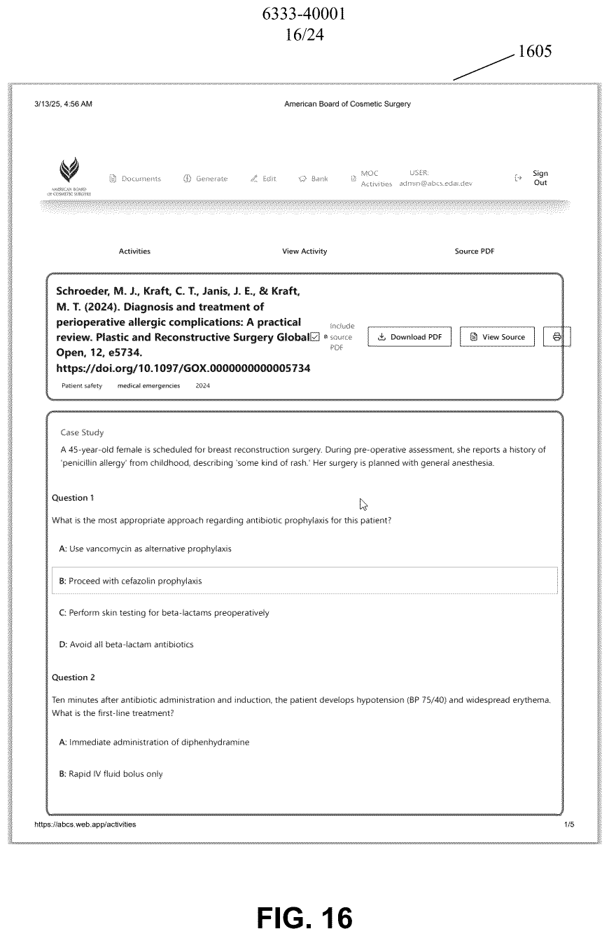

In FIG. 15, the MCQ and taxonomy module 130 implements real-time changes based on the feedback to improve the MCQ exam in an eight GUI example 1505. In FIG. 16, the final exam database 140 stores the improved MCQ exam in a ninth GUI example 1605.

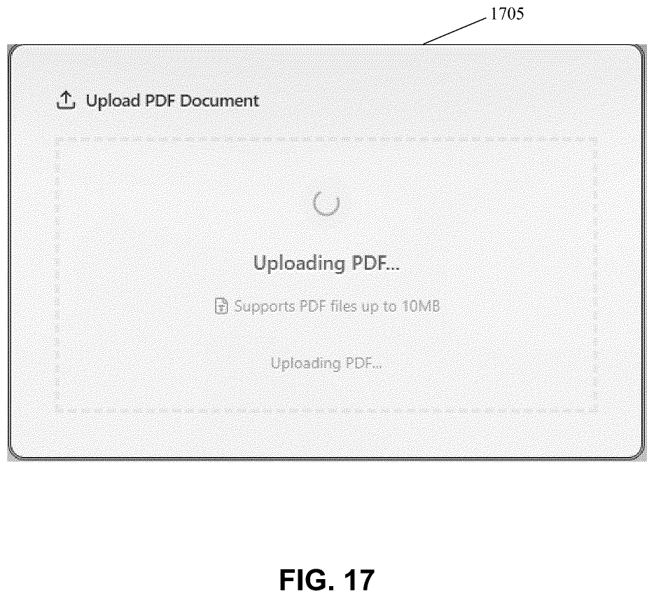

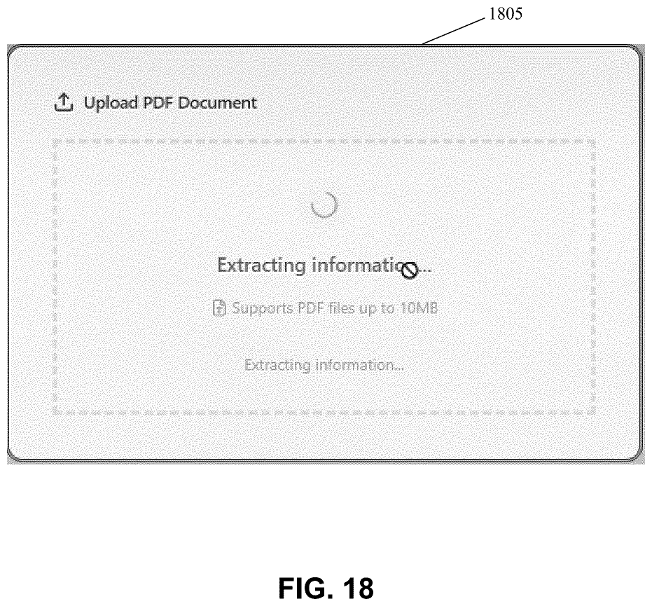

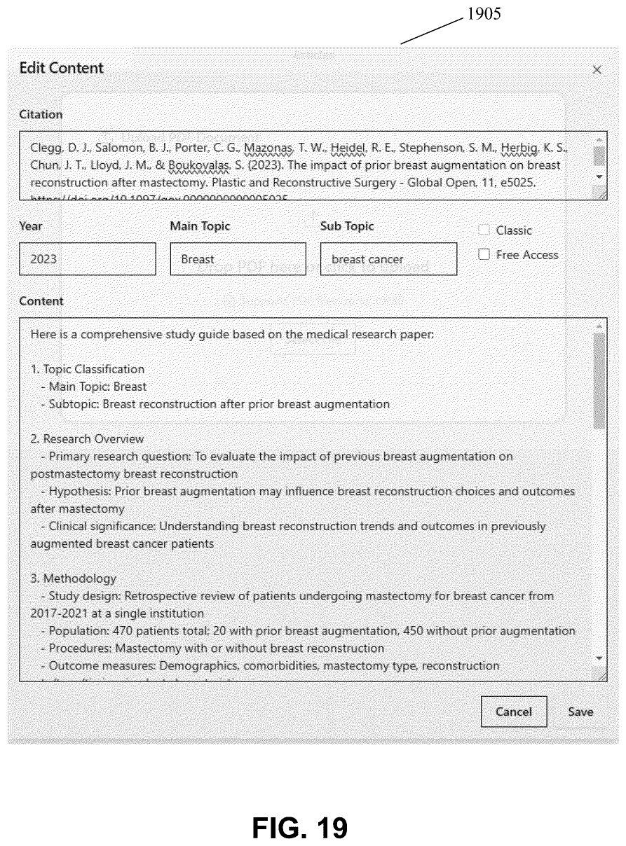

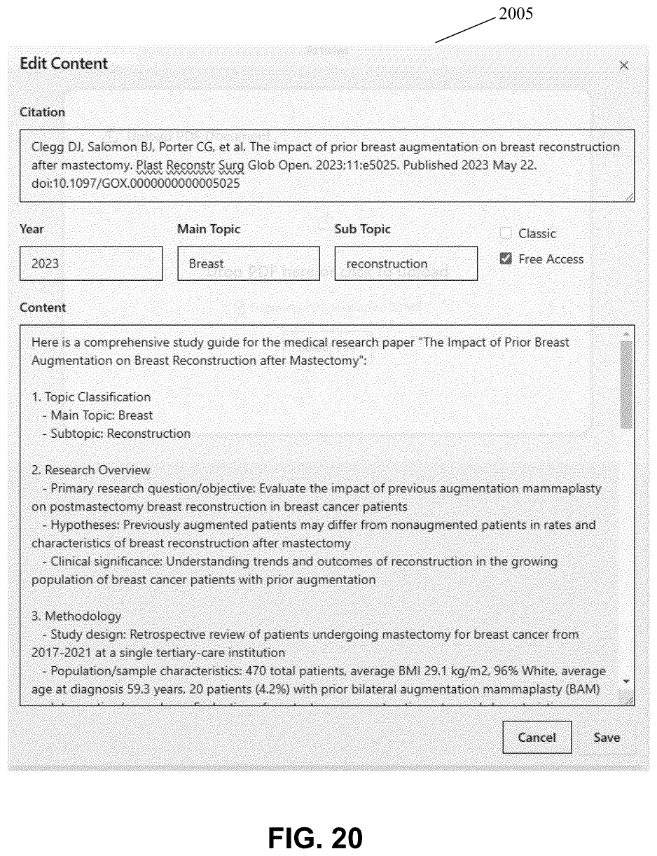

In FIG. 17, the image segmentation module 110 receives the PDF document and converts the PDF document to a JPEG file in a tenth GUI example 1705. In FIG. 18, the image segmentation module 110 converts the JPEG file to a text file by utilizing an AI vision workflow model in an eleventh GUI example 1805. In FIG. 19, the parse and classify module 115 parses and classifies the text file using a first LLM in a twelfth GUI example 1905. In FIG. 20, the study guide module 120 determines a textual study guide using the second LLM in a thirteenth GUI example 2005.

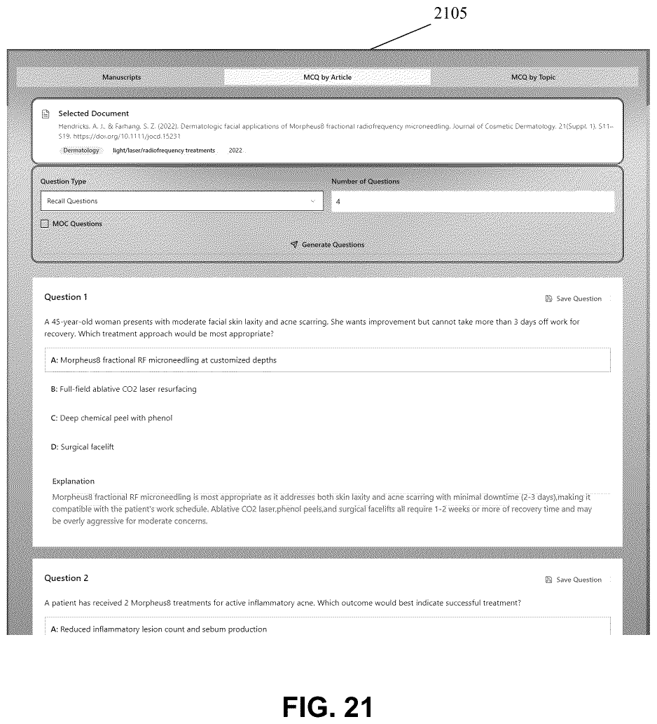

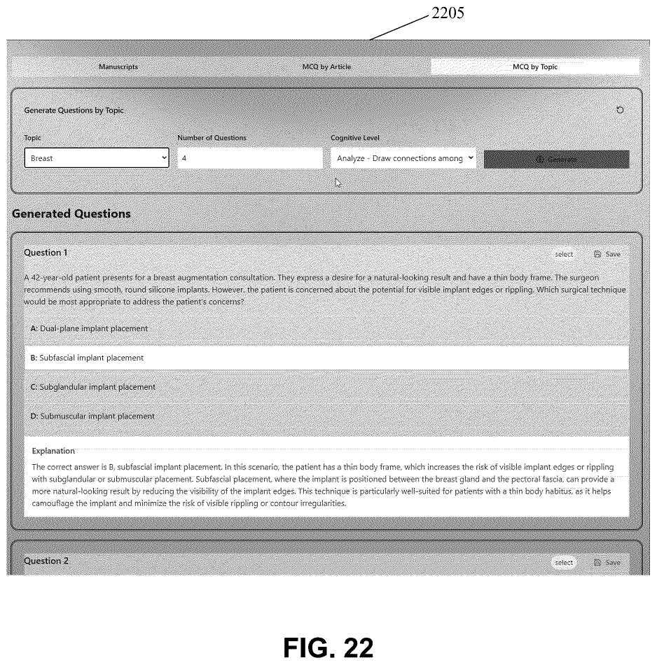

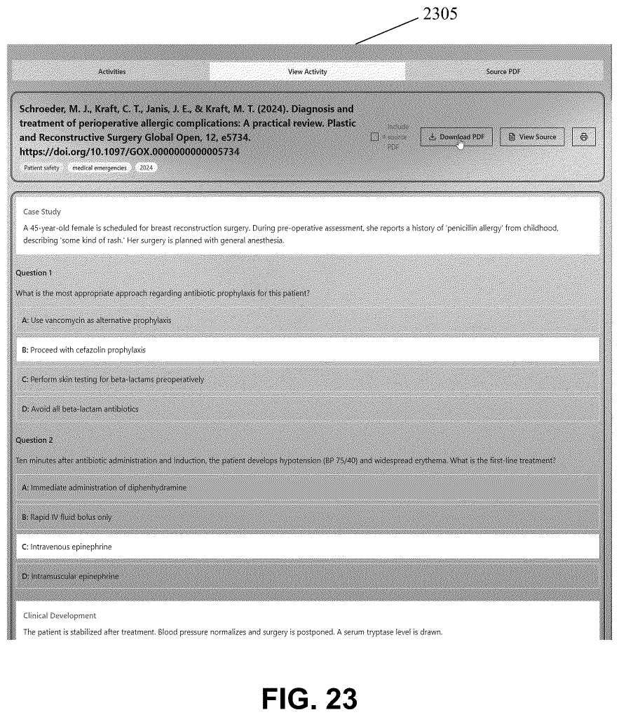

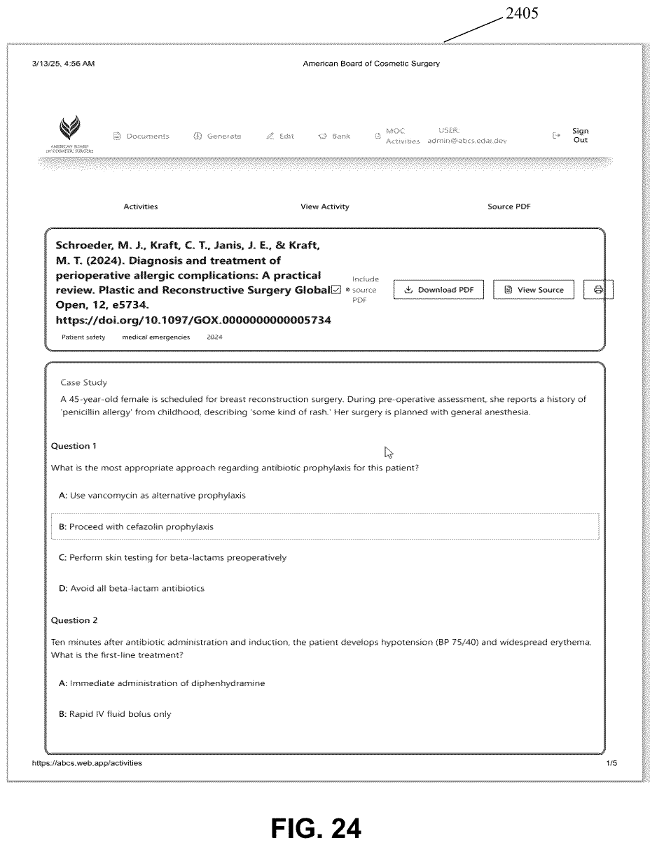

In FIG. 21, the question and answer module 125 generates a question and answer exam based on the textual study guide using the third LLM in a fourteenth GUI example 2105. In FIG. 22, the MCQ and taxonomy module 130 generates a MCQ exam based on the question and answer exam using a plurality of LLMs in a fifteenth GUI example 2205. In FIG. 23, the MCQ and taxonomy module 130 implements real-time changs to improve the MCQ exam in a sixteenth GUI example 2305. For example, the real-time changes can be based on user feedback or based on additional training. In FIG. 24, the final exam database 140 stores the improved MCQ exam in a seventeenth GUI example 2405.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a computing device, a portable document format (PDF) from a user computing device;
converting, by the computing device, the PDF to a JPEG file by utilizing an artificial intelligence (AI) image segmentation model;
converting, by the computing device, the JPEG file to a text file by utilizing an AI vision workflow model;
parsing and classifying, by the computing device, the text file using a first large language model (LLM);
determining, by the computing device, a textual study guide using a second LLM;
generating, by the computing device, a question and answer exam based on the textual study guide using a third LLM; and
generating, by the computing device, a multiple choice question (MCQ) exam based on the question and answer exam using a plurality of LLMs.

2. The computer-implemented method of claim 1, wherein the AI image segmentation model utilizes positional encodings, learned embeddings, and pre-trained text encoders to analyze the PDF document.

3. The computer-implemented method of claim 1, wherein the AI vision workflow model ingests and analyzes the JPEG file for object detection and converting the detected objects into the text file.

4. The computer-implemented method of claim 1, wherein the first LLM comprises a first generative transformer which is fine-tuned using reinforcement learning (RL).

5. The computer-implemented method of claim 4, wherein the first LLM parses the text file and classifies the text file by rapid data extraction and automatic labeling of the text file into a plurality of categories.

6. The computer-implemented method of claim 1, wherein the second LLM comprises a second generative transformer which is fine-tuned using reinforcement learning (RL).

7. The computer-implemented method of claim 6, wherein the second LLM provides visual reasoning of the classified text to generate the textual study guide including a plurality of categories.

8. The computer-implemented method of claim 1, wherein the third LLM comprises at least one generative transformer in a neural network architecture which is fine-tuned using reinforcement learning (RL).

9. The computer-implemented method of claim 8, wherein the third LLM receives the textual study guide and generates the question and answer exam by:
performing advanced reasoning and complex text analysis of the textual study guide; and
generating the question and answer exam based on the advanced reasoning and complex text analysis of the textual study guide.

10. The computer-implemented method of claim 1, wherein the plurality of LLMs comprises a psychometric analyzer LLM and a taxonomy analyzer LLM.

11. The computer-implemented method of claim 10, wherein the psychometric analyzer LLM evaluates and provides an assessment of reliability, validity, and a measure of intended psychological constructures of the question and answer exam to generate and improve the MCQ exam.

12. The computer-implemented method of claim 10, wherein the taxonomy analyzer LLM utilizes a classifier model to classify the question and answer exam into taxonomy categories to generate and improve the MCQ exam.

13. The computer-implemented method of claim 1, wherein the computing device includes software provided as a service in a cloud environment.

14. A computer program product comprising one or more computer readable storage media having program instructions collectively stored on the one or more computer readable storage media, the program instructions executable to:
receive a google document from a user computing device;
convert the google document to a text file by utilizing a conversion model;
parse and classify the text file using a first large language model (LLM);
determine a textual study guide using a second LLM;
generate a question and answer exam based on the textual study guide using a third LLM; and
generate a multiple choice question (MCQ) exam based on the question and answer exam using a plurality of LLMs.

15. The computer program product of claim 14, wherein the conversion model comprises a generative transformer which is fine-tuned using reinforcement learning (RL).

16. The computer program product of claim 14, wherein the first LLM parses the text file and classifies the text file by rapid data extraction and automatic labeling of the text file into a plurality of categories.

17. The computer program product of claim 14, wherein the second LLM provides visual reasoning of the classified text to generate the textual study guide including a plurality of categories.

18. The computer program product of claim 14, wherein the third LLM receives the textual study guide and generates the question and answer exam by:
performing advanced reasoning and complex text analysis of the textual study guide; and
generating the question and answer exam based on the advanced reasoning and complex text analysis of the textual study guide.

19. The computer program product of claim 14, wherein the plurality of LLMs comprises:
a psychometric analyzer LLM which evaluates and provides an assessment of reliability, validity, and a measure of intended psychological constructures of the question and answer exam to generate and improve the MCQ exam; and
a taxonomy analyzer LLM which utilizes a classifier model to classify the question and answer exam into taxonomy categories to generate and improve the MCQ exam.

20. A system comprising:
a processor, a computer readable memory, one or more computer readable storage media, and program instructions collectively stored on the one or more computer readable storage media, the program instructions executable to:
receive a portable document format (PDF) from a user computing device;
convert the PDF to a JPEG file by utilizing an artificial intelligence (AI) image segmentation model;
convert the JPEG file to a text file by utilizing an AI vision workflow model;
parse and classify the text file using a first large language model (LLM);
determine a textual study guide using a second LLM;
determine a semantic study guide based on the textual study guide using a vector embedding model;
generate a question and answer exam based on the textual study guide using a third LLM; and
generate a multiple choice question (MCQ) exam based on the question and answer exam using a plurality of LLMs.
